(19) United States
(12) Patent Application Publication
(10) Pub. No.: US 2007/0023650 A1
(43) Pub. Date: Feb. 1, 2007

(54) Irrigation control system and method

(76) Inventor: Dennis Allen, Wolfforth, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 11/477,690

(22) Filed: Jun. 29, 2006

Related U.S. Application Data
(60) Provisional application No. 60/696,043, filed on Jul. 1, 2005.

(51) Int. Cl. G21K 7/00

(52) U.S. Cl. 250/309

(57) ABSTRACT

An irrigation control system comprises a probe insertable into an area to be irrigated, the probe configured to generate a signal in response to an electrolytic response in the area. The system also comprises a valve activatable to provide a water supply to the area. The system further comprises an interface coupled to the probe and configured to, in response to receiving the signal from the probe, de-activate the valve

### RELATED APPLICATIONS

The present patent application claims priority to U.S. Provisional Patent Application No. 60,696,043, entitled, “AUTOMATIC WATER SYSTEM,” filed on Jul. 1, 2005.

### BACKGROUND OF THE INVENTION

Many irrigation systems are programmed to activate at specific times and/or according to a predetermined schedule for a preset duration to irrigate, for example, a homeowner's lawn, a golf course, an athletic field or cropland. These systems are generally configured to operate without regard to the level of moisture already present in the soil. Thus, these systems can lead to over-watering. Further, these irrigation systems generally do not provide an indication of how much water has been applied or how deep the watering has been applied.

### BRIEF DESCRIPTION OF THE DRAWINGS

FIG. 1 is a diagram illustrating an embodiment of an irrigation control system in accordance with the present invention;

FIG. 2 is a diagram illustrating an enlarged view of an embodiment of a probe of the system illustrated in FIG. 1 in accordance with the present invention; and

FIG. 3 is a diagram illustrating an embodiment of an interface control circuit of the system illustrated in FIG. 1 in accordance with the present invention.

### DETAILED DESCRIPTION OF THE DRAWINGS

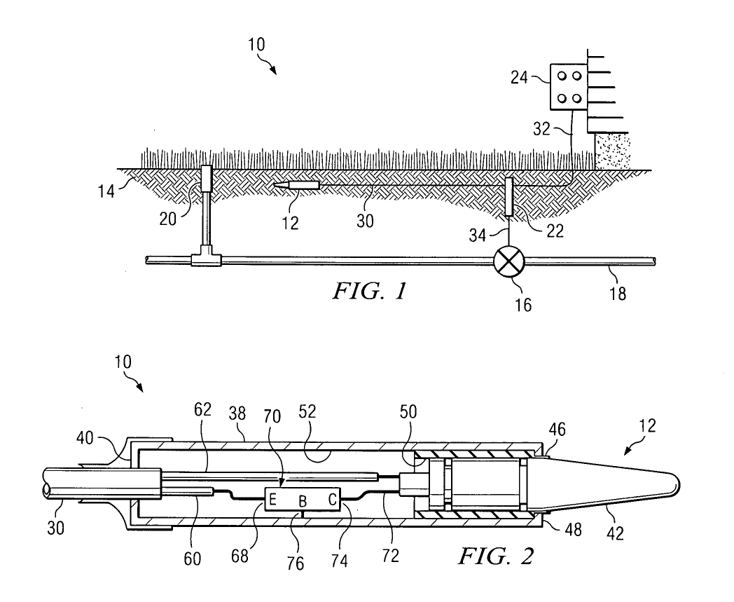

The preferred embodiments of the present invention and the advantages thereof are best understood by referring to FIGS. 1-3 of the drawings, like numerals being used for like and corresponding parts of the various drawings.

FIG. 1 is a diagram illustrating an embodiment of an irrigation control system 10 in accordance with the present invention. In the embodiment illustrated in FIG. 1, system 10 comprises a probe 12 insertable into an area 14 to be watered or irrigated (e.g., probe 12 may be inserted into and/or buried within soil or another type of material to a desired and/or predetermined depth). In the embodiment illustrated in FIG. 1, system 10 also comprises an electronically controllable valve 16 for controlling a water supply 18 for providing water to area 14 (e.g., via a sprinkler 20). In FIG. 1, system 10 also comprises an interface 22 and a timer 24. Timer 24 generally comprises a timing mechanism and/or other control features to facilitate irrigation of area 14 according to a predetermined schedule and/or duration, controls for each zone of an irrigation area 14, and/or controls for the manual or semi-automatic operation of system 10. Interface 22 is also used to control activation and de-activation of valve 16 based on a signal or input from probe 12. In the embodiment illustrated in FIG. 1, probe 12 is communicatively coupled to interface 22 via an electrical conduit or cable 30, interface 22 is communicatively coupled to timer 24 via an electrical conduit or cable 32, and interface 22 is communicatively coupled to valve 16 via an electrical conduit or cable 34; however, it should be understood that other types of signal and/or electrical mediums, including wireless, may be used to communicate information and/or signals between various components of system 10.

FIG. 2 is a diagram illustrating an enlarged view of an embodiment of probe 12 of system 10 illustrated in FIG. 1 in accordance with the present invention. In the embodiment illustrated in FIG. 2, probe 12 comprises a housing 38 configured to receive cable 30 at an end 40 thereof, and a tip 42 disposed at least partially within an interior area 44 of housing 38 and extending outwardly from housing 38 through an opening 46 formed in end 48 of housing 38 opposite end 40. Preferably, housing 38 is configured having a cylindrical cross-section having an open and/or hollow interior area 44. However, it should be understood that housing 38 may be configured having different geometrical shapes. Further, it should be understood that various portions of housing 38 may be solid and/or non-hollow.

In the embodiment illustrated in FIG. 2, an insulator 50 is disposed about an interior wall 52 of housing 38 and about opening 46 such that tip 42 is electrically insulated from housing 38. Insulator 50 may comprise a ceramic or other type of suitable material for electrically insulating tip 42 from housing 38. Preferably, housing 38 is formed from nickel chromium plated copper, and tip 42 is formed from galvanized steel; however, other dissimilar metals may be used to form housing 38 and tip 42, respectively, such that, in response to an electrolytic environment or condition within area 14 in contact with and/or in close proximity to probe 12, the dissimilar materials of housing 38 and tip 42 cause an electrolytic response current to flow between housing 38 and tip 42. For example, salts and/or minerals present within water and/or soils act as an electrolyte and cause an electrolytic current flow between various types of dissimilar metals. Thus, embodiments of the present invention use the presence of an electrolytic condition within area 14 to sense or detect moisture within area 14.

In the embodiment illustrated in FIG. 2, cable 30 carries a pair of electrical conduits 60 and 62 where conduit 62 is coupled to tip 42 and conduit 60 is coupled to an emitter 68 of a transistor 70 disposed within probe 12. Tip 42 is coupled via a conduit 72 to a collector 74 of transistor 70, and wall 52 of housing 38 is coupled to a base 76 of transistor 70.

Thus, in operation, in response to an electrolytic condition in contact with and/or otherwise in the vicinity of probe 12, the salts, minerals and/or water act as an electrolyte and cause hydrogen bubbles to form and transfer between tip 42 and housing 38 within area 14 carrying minute amounts of zinc, thereby generating a current flow from tip 42 to housing 38 through area 14. In response to the current flow in area 14 from tip 42 to housing 38, transistor 70 is turned on, thereby causing a signal to be transmitted from probe 12 to interface 22 (FIG. 1) (e.g., approximately 0.6-0.7 volts). Thus, in operation, minerals and salts that are in the water and/or within the soil in area 14 (FIG. 1) cause an electrolytic response between tip 42 and housing 38, thereby generating a current flow between tip 42 and housing 38 and causing a signal to be generated and transmitted by probe 12 to interface 22. Further, in the absence of moisture or water, or the absence of salts and other minerals that are used to form an electrolytic response (e.g., should the minerals and salts in the soil in the area 14 be washed below a location of probe 12), the electrolytic response between tip 42 and housing 38 cessates, thereby causing a cessation of the signal from probe 12 to interface 22.

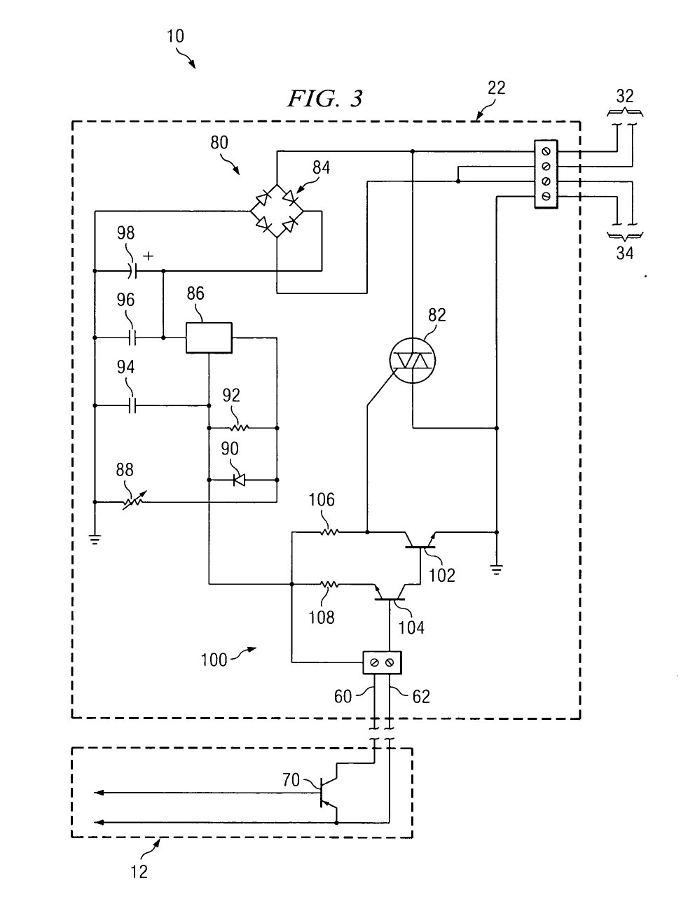

FIG. 3 is a diagram illustrating an embodiment of interface 22 of system 10 illustrated in FIG. 1 in accordance with the present invention. In the embodiment illustrated in FIG. 3, interface 22 comprises an interface circuit 80 comprising a triode for alternating current (TRIAC) 82, a full bridge rectifier 84, a voltage regulator chip 86, a variable resistor 88, a diode 90, a resistor 92, ceramic capacitors 94 and 96, an electrolytic capacitor 98, and an inverter circuit 100 coupled together as illustrated in FIG. 3. Inverter circuit 100 comprises transistors 102 and 104 and resistors 106 and 108 coupled together as illustrated in FIG. 3. As illustrated in FIG. 3, interface 22 is coupled to probe 12 via conduits 60 and 62. Further, interface 22 is coupled to valve 16 via conduit 34 (FIG. 1) and coupled to timer 24 via conduit 32 (FIG. 1).

In operation, alternating current (AC) power is supplied to interface 22 via conduit 32 from timer 24 (FIG. 1). However, it should be understood that power may be otherwise provided to interface 22. Full bridge rectifier 84, voltage regulator chip 86 and other components of interface circuit 80 convert the AC power to direct current (DC) power and control a DC voltage supply to valve 16 (FIG. 1) to activate valve 16 (i.e., turn valve 16 on) for providing water supply 18 to area 14 and de-activating valve 16 (i.e., turning valve 16 off) to cease providing water supply 18 to area 14. For example, in response to receiving a signal from timer 24 to activate valve 16 to initiate irrigation of area 14 according to a predetermined schedule or in response to manual control, interface circuit 80 transmits a signal and/or power to valve 16 to activate valve 16. De-activation of valve 16 is performed in a similar manner.

In some embodiments of the present invention, the signal generated by probe 12 is used to control activation and de-activation of valve 16, including overriding activation of valve 16 in response to an activation signal received from timer 24 (e.g., preventing activation of valve 16 even if timer 24 is trying to activate valve 16). For example, in response to receiving a signal from probe 12 indicative of an electrolytic response within area 14, inverter circuit 100 is used to invert the signal received from probe 12 and cause TRIAC 82 to be turned off, thereby maintaining valve 16 in a de-activated mode (i.e., valve 16 turned off). Thus, in operation, in response to an electrolytic response at probe 12 (e.g., indicative of moisture and/or salts and minerals present at a location of probe 12 within area 14), interface circuit 80 maintains valve 16 in a de-activated or off mode even if timer 24 is scheduled to activate valve 16. Thus, embodiments of the present invention substantially prevent or eliminate an over-watering of area 14. Further, in operation, in response to an absence of an electrolytic response at probe 12, no signal is generated or transmitted from probe 12 to interface 22, thereby resulting in TRIAC 82 being turned on and enabling activation of valve 16 based on timer 24 signals.

Thus, embodiment of the present invention use an electrolytic response within an area to be irrigated resulting from water, salts and/or minerals within the area as an indication of adequate moisture content at a location of probe 12, thereby substantially preventing or eliminating over-watering of area 14. Further, embodiments of the present invention provide a more accurate indication of a depth of watering. For example, probe 12 may be inserted and/or otherwise buried to a predetermined or desired depth within area 14. As area 14 is watered or irrigated, the water washes the salts and/or minerals used to generate an electrolytic response at probe 12 toward and to probe 12 and, in response to the water, salts and/or minerals reaching probe 12, the electrolytic response is generated, thereby causing valve 16 to be de-activated and the watering ceased. Correspondingly, as the area 14 around probe 12 becomes dry, the electrolytic response cessates and, in the absence of a signal from probe 12 at interface 22, the valve 16 is activatable again by timer 24. Thus, embodiments of the present invention automatically turn off an irrigating water supply in response to watering to a predetermined depth within area 14.

What is claimed is:

1. An irrigation control system, comprising:
a probe insertable into an area to be irrigated, the probe configured to generate a signal in response to an electrolytic response in the area;
a valve activatable to provide a water supply to the area; and
an interface coupled to the probe and configured to, in response to receiving the signal from the probe, de-activate the valve.

2. The system of claim 1, wherein the interface is configured to, in response to cessation of the signal, activate the valve.

3. The system of claim 1, wherein the probe comprises a transistor for generating the signal.

4. The system of claim 1, further comprising a timer configured to cause activation of the valve according to a predetermined schedule.

5. The system of claim 4, wherein the interface is configured to override the timer to maintain de-activation of the valve in response to receiving the signal.

6. The system of claim 1, wherein the interface comprises an inverter circuit.

7. The system of claim 1, wherein the probe comprises a transistor coupled to a probe housing and a probe tip insulated from the probe housing.

8. An irrigation control system, comprising:
means, insertable into an area to be irrigated, for generating a signal in response to an electrolytic response in the area;
activatable means for providing a water supply to the area; and
means coupled to the generating means and, in response to receiving the signal from the generating means, for de-activating the providing means.

9. The system of claim 8, wherein the generating means comprises a transistor means.

10. The system of claim 8, wherein the de-activating means comprises means for activating the providing means in response to cessation of the signal.

11. The system of claim 8, further comprising means for causing activation of the providing means according to a predetermined schedule.

12. The system of claim 11, wherein the de-activating means is configured to override the means for causing activation to maintain de-activation of the providing means in response to receiving the signal.

13. A method for irrigation control, comprising:
generating, by a probe insertable into an area to be irrigated, a signal in response to an electrolytic response in the area; and
maintaining a valve configured to be activated to provide a water supply to the area in a de-activated mode in response to receiving the signal.

14. The method of claim 13, further comprising enabling activation of the valve in response to cessation of the signal.

15. The method of claim 13, further comprising inverting the signal received from the probe.

16. The method of claim 13, further comprising enabling activation of the valve via a timer according to a predetermined schedule.

17. The method of claim 16, further comprising overriding the timer to maintain the valve in a de-activated mode in response to receiving the signal.

18. The method of claim 13, wherein generating the signal comprises receiving a current through a transistor disposed in the probe in response to the electrolytic response.

19. The method of claim 13, wherein generating the signal comprises sensing a current flow between a housing of the probe and a tip of the probe insulated from the housing.
